(19) United States
(12) Patent Application Publication
(10) Pub. No.: US 2026/0209498 A1
(43) Pub. Date: Jul. 23, 2026

(54) BLENDED POLYPROPYLENE COMPOSITION

(71) Applicant: SABIC GLOBAL TECHNOLOGIES B.V., Bergen op Zoom (NL)

(72) Inventors: Junhua ZHANG, Etten-Leur (NL); Dimphna Johanna Maria VAN BEEK, Sittard (NL); Johannes Peter Antonius MARTENS, Geleen (NL); Jan Nicolaas Eddy DUCHATEAU, Tessenderlo (BE)

(21) Appl. No.: 19/138,928

(22) PCT Filed: Dec. 13, 2023
(86) PCT No.: PCT/EP2023/085472

§ 371 Date: Jun. 13, 2025

(30) Foreign Application Priority Data
Dec. 16, 2022 (EP) 22214308.3

(51) Int. Cl. C08L 23/16; C08J 3/20

(52) U.S. Cl. CPC C08L 23/16; C08J 3/201; C08J 2323/16; C08J 2423/08; C08J 2423/12; C08J 2423/16; C08L 2203/30; C08L 2205/025; C08L 2205/035; C08L 2207/02; C08L 2207/20

(57) ABSTRACT

A blended polypropylene composition, a process for making a blended polypropylene composition and the composition obtainable thereby, and the use of a recycled composition obtained by processing a waste plastic material derived from post-consumer and/or post-industrial waste for improving impact strength and gloss of a blended polypropylene composition.

### CROSS REFERENCE TO RELATED APPLICATIONS

This application is a National Stage Application of PCT/EP2023/085472, filed Dec. 13, 2023, which claims the benefit of European Application No. 22214308.3, filed Dec. 16, 2022, both of which are incorporated by reference in their entirety herein.

### BACKGROUND

The present invention relates to a blended polypropylene composition, a process for making a blended polypropylene composition and the composition obtainable thereby.

Compositions comprising a heterophasic propylene copolymer and an inorganic filler are widely used for applications requiring good mechanical properties such as impact strength. Certain applications require not only mechanical properties but also gloss performance, and more advantageously also scratch resistance.

The process for recycling polypropylene is known in the art, e.g. WO2012117250, U.S. Pat. No. 9,670,344 and WO2014040634. But the recycled polypropylene typically suffers from degradation of performances comparing to virgin polypropylene. One typical solution to this issue is diluting the recycled polypropylene in a virgin polypropylene to obtain a polypropylene blend, however the polypropylene blend also typically suffers from the degradation of the recycled polypropylene.

### SUMMARY

It is an objective of the present invention to provide a blended propylene composition with improvements in both impact strength and gloss. It is another objective of the present invention to provide a blended propylene composition with improvements in impact strength, gloss and scratch resistance.

In one aspect of the invention, there is provided a blended propylene composition, comprising
(A) 5 to 50 wt % of a recycled polypropylene composition with a melt flow index of 10 to 50 dg/min as measured according to ISO1133-1:2011 at 230° C. with 2.16 kg load,
(B) 30 to 70 wt % of at least one heterophasic propylene copolymer with a melt flow index of 10 to 90 dg/min as measured according to ISO1133-1:2011 with 2.16 kg load at 230° C.,
(C) 5 to 30 wt % of an inorganic filler, and
(D) 5 to 30 wt % of at least one polyolefin based elastomer.

### DETAILED DESCRIPTION

In comparison with a baseline composition obtained by replacing the recycled polypropylene composition in the blended propylene composition with the same amount of the at least one heterophasic propylene copolymer,
the Izod notched impact strength of the blended propylene composition, measured by ISO180/1A (II) at 23° C., is increased by at least 10%; and/or
the gloss of the blended propylene composition, measured by ISO 2813 at 20 degrees, is increased by at least 10%.

In some instances, the scratch resistance of the blended composition, measured according to the PV 3952 (2002) scratch method of Volkswagen AG company on an Erichsen scratching device with a load of 10N, is decreased by at least 5%.

In another aspect of the invention, there is provided a process for making a blended composition, comprising the steps of:
i) processing a waste plastic material derived from post-consumer and/or post-industrial waste to obtain (A) a recycled composition,
ii) melt-mixing the recycled composition with (B) at least one heterophasic propylene copolymer, (C) an inorganic filler and (D) at least one polyolefin based elastomer.

In some instances, the Izod notched impact strength of the blended composition is increased by 10 to 50%, preferably 15 to 45%, more preferably 17% to 41%.

In some instances, the gloss of the blended composition is increased by 10 to 200%, preferably 15 to 190%, more preferably 19 to 180%.

In some instances, the scratch resistance of the blended composition is decreased by 5 to 90%, preferably 7 to 80%, more preferably 8 to 70%.

In some instances, the Izod notched impact strength of the blended composition is in the range of 37 to 60 kJ/m², preferably 39 to 50 kJ/m².

In some instances, the gloss of the blended composition is in the range of 7.0 to 30, preferably 8 to 20.

In some instances, the scratch resistance of the blended composition is in the range of 1.0 to 6.2, preferably 1.9 to 6.0.

It was surprisingly found that mixing the specific type of the recycled composition with an inorganic filler-filled composition comprising the specific type of the heterophasic propylene copolymer according to the invention results in improved impact strength, gloss and/or scratch resistance at a low cost.

### Process for Making Blended Composition

The process according to the invention comprises the steps of
i) processing a waste plastic material derived from post-consumer and/or post-industrial waste to obtain (A) a recycled polypropylene composition,
ii) melt-mixing the recycled polypropylene composition with (B) at least one heterophasic propylene copolymer, (C) an inorganic filler and (D) at least one polyolefin based elastomer.

In step i), post-consumer and/or post-industrial waste is processed by known methods involving e.g. washing, sorting and/or grinding to obtain the recycled composition. The recycled composition obtained by step i) may be in the form of pellets.

In step ii), the so-obtained recycled composition and the heterophasic propylene copolymer, the inorganic filler and the polyolefin based elastomer, as well as optionally further additives are melt-mixed by using any suitable means to obtain the blended composition according to the invention.

Preferably, the blended composition of the invention is made in a form that allows easy processing into a shaped article in a subsequent step, like in pellet or granular form.

Preferably, the blended composition of the invention is in pellet or granular form as obtained by mixing all components in an apparatus like an extruder; the advantage being a composition with homogeneous and well-defined concentrations of the additives.

### (A) Recycled Composition

The recycled composition used in the present invention is obtained by processing a waste plastic material derived from post-consumer and/or post-industrial waste, preferably derived from post-industrial waste, by known methods involving e.g. washing, sorting and/or grinding.

The recycled composition comprises a propylene-based polymer at an amount of at least 90 wt %, preferably at least 92 wt %, more preferably at least 95 wt %, even more preferably at least 98 wt %, with respect to the recycled composition. Herein, a propylene-based polymer is understood as a propylene homopolymer, a propylene copolymer including random copolymers and (multi)block copolymers or a heterophasic propylene copolymer, having propylene monomer units at an amount of at least 50 wt %, for example at least 80 wt %.

The waste plastic material may comprise substantially the same amount of the propylene-based polymer as the recycled composition. The waste plastic material may comprise a propylene-based polymer at an amount of at least 90 wt % with respect to the waste plastic material.

The recycled composition has an ash content as determined by ISO 3451 of less than 10 wt % with respect to the recycled composition, preferably at most 8 wt %, at most 6 wt %, at most 5 wt %, at most 3 wt % or at most 1 wt %. The low ash content may lead to a better aesthetical quality and allow better control of the amount of the inorganic material in the blended composition of the invention.

The recycled composition has a melt flow index as determined by ISO1133-1:2011 at 230° C. with 2.16 kg load of 10 to 100 dg/min, preferably 10 to 50 dg/min, more preferably 15 to 30 dg/min, more preferably 18 to 22 dg/min, such as 20 dg/min.

Preferably, the ratio of the melt flow index of the recycled composition to the melt flow index of the propylene-based matrix of the heterophasic propylene polymer is 0.1 to 5.0, preferably 0.2 to 2.0, for example, 0.25 to 1.5. Both melt flow index are determined by ISO1133-1:2011 at 230° C. with 2.16 kg load.

The recycled composition has an Izod notched impact strength as determined by ISO180/1A (II) at 23° C. of 2.0 to 7.0 kJ/m², for example 4.0 to 5.0 kJ/m².

The recycled composition has a flexural modulus as determined by ISO178 (parallel) at 23° C. of 1000 to 1500 MPa, for example 1300 to 1400 MPa.

This results in the blended composition according to the invention having good mechanical properties.

Preferably, the amount of the recycled composition with respect to the blended composition according to the invention is 5 to 50 wt %, preferably 7 to 35 wt %, more preferably 10 to 30 wt %, and even more preferably 15 to 25 wt %.

Preferably, the weight ratio of the recycled composition with respect to the heterophasic propylene copolymer is 1:10 to 1:1, preferably 1:5 to 4:5, more preferably 1:5 to 3:5.

### (B) Heterophasic Propylene Copolymer

The blended composition according to the present invention comprises at least one heterophasic propylene copolymer. Preferably, the amount of the heterophasic propylene copolymer with respect to the blended composition according to the invention is 30-70 wt %, preferably 35-65 wt %, more preferably 40-60 wt %, such as 45 wt %, 50 wt % or 55 wt %.

For the purpose of the invention, unless otherwise specified, the amount of the heterophasic propylene copolymer means the total amount of the at least one heterophasic propylene copolymer.

The heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %.

Heterophasic propylene copolymers, also known as impact propylene copolymers or propylene block copolymers, are an important class of polymers due to their attractive combination of mechanical properties, such as impact strength over a wide temperature range and their low cost. These copolymers find a wide range of applications ranging from the consumer industry (for example packaging and housewares), the automotive industry, to electrical applications.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the heterophasic propylene copolymer is made using Ziegler-Natta catalyst. The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer.

These steps are preferably performed in different reactors. The catalyst systems for the first step and for the second step may be different or same.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexene, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

Preferably, the propylene-based matrix is present in an amount of 70 to 90 wt %, preferably 74 to 86 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 34 to 58 wt %, preferably 44 to 48 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexene, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFIrubber, may be for example at least 0.001 dg/min, at least 0.03 dg/min or at least 0.05 dg/min, and/or for example at most 0.1 dg/min or 0.01 dg/min. MFIrubber is calculated according to the following formula:

$$MFIrubber = {10}^{⋀} ( \frac{Log MFIheterophasic - matrix content * Log MFImatrix}{rubber content} )$$

wherein MFIheterophasic is the MFI (dg/min) of the heterophasic propylene copolymer measured according to ISO1133-1:2011 (2.16 kg/230° C.), MFImatrix is the MFI (dg/min) of the propylene-based matrix measured according to ISO1133-1:2011 (2.16 kg/230° C.), matrix content is the fraction of the propylene-based matrix in the heterophasic propylene copolymer, rubber content is the fraction of the dispersed ethylene-α-olefin copolymer in the heterophasic propylene copolymer. The sum of the matrix content and the rubber content is 1. For the avoidance of any doubt, Log in the formula means log₁₀.

Preferably, the dispersed ethylene-α-olefin copolymer is present in an amount of 10 to 30 wt %, preferably 14 to 26 wt %, based on the total heterophasic propylene copolymer.

In the heterophasic propylene copolymer in the composition of the invention, the sum of the total weight of the propylene-based matrix and the total weight of the dispersed ethylene-α-olefin copolymer is 100 wt % of the heterophasic propylene copolymer. The heterophasic propylene copolymer can be divided into a xylene-soluble part (CXS) and a xylene-insoluble part (CXI). Preferably, the xylene soluble part of the heterophasic propylene copolymer is in the range from 12.9 to 27.8 wt %, preferably 13 to 22 wt %, based on the total amount of the heterophasic propylene copolymer as measured according to ISO16152:2005.

Preferably, in the heterophasic propylene copolymer according to the invention, the comonomer in the propylene-α-olefin copolymer is selected from ethylene and the group of α-olefins having 4 to 10 carbon atoms and the α-olefin in the ethylene-α-olefin copolymer is selected from the group of α-olefins having 3 to 8 carbon atoms. Most preferably, in the heterophasic propylene copolymer according to the invention, the comonomer in the propylene-α-olefin copolymer is ethylene and the α-olefin in the ethylene-α-olefin copolymer is propylene.

The values of the MFI of the propylene-based matrix (MFImatrix) and the MFI of the dispersed ethylene-α-olefin elastomer (MFIrubber) mentioned herein are understood as the values before the heterophasic propylene copolymer is mixed with other components to obtain the composition according to the invention.

The value of the MFI of the heterophasic propylene copolymer (MFIheterophasic) refers to the original MFI value of the heterophasic propylene copolymer, before subjecting to vis-breaking or shifting by melt-mixing with a peroxide.

The heterophasic propylene copolymer is preferably a reactor grade heterophasic propylene copolymer.

Preferably, the xylene soluble part of the heterophasic propylene copolymer has an intrinsic viscosity, IV_{CXS}, as determined by ISO1628-1:2009 in decalin at 135° C. of 3.5 to 6.0 dl/g, preferably 3.8 to 5.5 dl/g.

Preferably, the xylene insoluble part of the heterophasic propylene copolymer has an intrinsic viscosity, IV_{CXI}, as determined by ISO1628-3:2010 in decalin at 135° C. of 1.28 to 1.50, preferably 1.3 to 1.4 dl/g.

Preferably, IV_{CXS}/IV_{CXI} is in the range from 2 to 5, preferably from 2.5 to 4.5, in which, IV_{CXS} is the intrinsic viscosity of the xylene soluble part of the heterophasic propylene copolymer, and IV_{CXI} is the intrinsic viscosity of the xylene insoluble part of the heterophasic propylene copolymer.

The heterophasic propylene copolymer in the composition according to the invention has a melt flow index as measured according to ISO1133-1:2011 (2.16 kg/230° C.) of 10 to 90 dg/min, preferably 12 to 86 dg/min, such as at most 84 dg/min, at most 82 dg/min, at most 80 dg/min or at most 79 dg/min.

In some instances, the blended composition of the present invention comprises two or more heterophasic propylene copolymers with different comonomers and/or MFIs.

### (C) Inorganic Filler

The blended composition according to the present invention further comprises an inorganic filler.

Suitable examples of inorganic fillers include but are not limited to talc, calcium carbonate, wollastonite, barium sulfate, kaolin, glass flakes, glass fibers, laminar silicates (bentonite, montmorillonite, smectite) and mica and mixtures thereof.

For example, the inorganic filler is chosen from the group of talc, calcium carbonate, wollastonite, mica and mixtures thereof. More preferably, the inorganic filler is talc.

The mean particle size of talc (D50) of talc is preferably in the range from 0.1 to 10.2 micron, preferably from 0.3 to 8.1 micron, more preferably from 0.5 to 5.2 micron, even more preferably from 0.6 to 2.5 micron according to sedimentation analysis, Stokes' law (ISO 13317-3:2001).

Preferably, the amount of the inorganic filler with respect to the blended composition is 5.0 to 30 wt %, preferably 10 to 25 wt %, more preferably 15 to 23 wt %.

### (D) Polyolefin-Based Elastomer

The blended composition according to the present invention further comprises at least one polyolefin-based elastomer.

The polyolefin-based elastomer is preferably selected from a group consisting of ethylene-1-butene copolymer, ethylene-1-hexene copolymer, ethylene-1-octene copolymer and mixtures thereof, more preferably, the elastomer is selected from ethylene-1-octene copolymer or ethylene-1-octene copolymer, or mixtures thereof.

Preferably the density of the polyolefin based elastomer is in the range from 0.845 to 0.883 g/cm3, preferably in the range from 0.853 to 0.875 g/cm3, more preferably in the range from 0.860 to 0.870 g/cm3 as measured according to ASTM D792-13.

Preferably the MFI of the polyolefin based elastomer is in the range from 0.3 to 18.0, preferably in the range from 0.5 to 14.2 dg/min as measured according to ASTM D1238-13, 190° C., 2.16 kg.

The shore A hardness of the polyolefin based elastomer is preferably in the range from 35 to 90, preferably in the range from 42 to 69, more preferably in the range from 47 to 60 as measured according to ASTM D2240-15, 1 s.

The polyolefin-based elastomers which are suitable for use in the current invention are commercially available for example under the trademark EXACT™ available from Exxon Chemical Company of Houston, Texas, or under the trademark ENGAGE™ polymers, a line of metallocene catalyzed elastomers available from Dow Chemical Company of Midland, Michigan, or under the trademark TAFMER™ available from MITSUI Chemicals Group of Minato Tokyo, or under the trademark Fortify™ and Cohere™ available from SABIC.

The polyolefin-based elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomers may also be prepared using traditional types of heterogeneous multi-sited Ziegler-Natta catalysts.

Preferably, the amount of ethylene incorporated into the polyolefin-based elastomer is at least 45 wt %. More preferably, the amount of ethylene incorporated into the polyolefin based elastomer is at least 48 wt %, for example at least 50 wt %. The amount of ethylene incorporated into the polyolefin based elastomer may typically be at most 95 wt %, for example at most 85 wt %, for example at most 75 wt %, for example at most 65 wt %, for example at most 60 wt %, for example at most 58 wt %.

The amount of the polyolefin based elastomer with respect to the blended composition is 5-30 wt %, preferably 10-25 wt %, more preferably 15-22 wt %.

For the purpose of the invention, unless otherwise specified, the amount of the polyolefin based elastomer means the total amount of the at least one polyolefin based elastomer.

In some instances, the blended composition of the present invention comprises two or more polyolefin-based elastomer with different comonomers and/or MFIs.

Preferably, the total of (A), (B), (C) and (D) with respect to the blended composition is at least 90 wt %, at least 95 wt %, at least 98 wt %, at least 99 wt % or 100 wt %.

### (E) Additives

The blended composition according to the present invention may further contain additives, for instance nucleating agents and clarifiers, stabilizers, release agents, plasticizers, anti-oxidants, lubricants, anti-statics, cross linking agents, scratch resistance agents, high performance fillers, pigments and/or colorants, flame retardants, blowing agents, acid scavengers, recycling additives, anti-microbials, anti-fogging additives, slip additives, anti-blocking additives, polymer processing aids and the like. Such additives are well known in the art. The amount of the additives is preferably at least 0.1 wt % and at most 5.0 wt %, preferably at most 4.5 wt %, preferably at most 4.0 wt %, more preferably at most 3.8 wt % based on the total amount of the blended composition.

Preferably, the total of (A), (B), (C), (D) and (E) with respect to the blended composition is 100 wt %.

### Further Aspects

The invention further relates to an article comprising the composition according to the invention, preferably wherein the article is an automotive part, preferably wherein the amount of the polymer composition according to the present invention is at least 95 wt %, preferably at least 98 wt % based on the total amount of the article.

Preferably, the automotive part is selected from the group consisting of exterior and interior, visible and partly visible applications, like bumper fascias, rocker panels, trims, cowl tops, cowl vent grill, windshield plenum, door panel, IP trim parts, seat claddings, center console, cup holders and arm, glove compartment and under-the-hood applications, like head-lamp housings.

The invention further relates to use of (A) a recycled composition obtained by processing a waste plastic material derived from post-consumer and/or post-industrial waste for improving impact strength, gloss and/or scratch resistance of a composition comprising (B) at least one heterophasic propylene copolymer, (C) an inorganic filler and (D) at least one polyolefin based elastomer.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### MATERIALS USED

IPC1 and IPC2 are heterophasic propylene copolymers prepared in an Innovene™ process, wherein a sequential two-reactor setup was employed. Polypropylene homopolymers were produced in first reactor and propylene-ethylene copolymers were produced in the second reactor.

There were three components in the catalyst system in the polymerization process: A procatalyst, an external electron donor and a co-catalyst. The procatalyst was prepared according to the description in WO2016198344, page 36, “Procatalyst III” paragraph; The external electron donor used for IPC2 was di(iso-propyl) dimethoxysilane (DiPDMS), the external electron donor used for IPC1 was n-propyltriethoxysilane (nPTES); the co-catalyst was triethylaluminium.

The process conditions for the production of IPC1 and IPC2 are given in Table 1.

TABLE 1
Preparation conditions of IPC1 and IPC2.

| Polymer | IPC1 | IPC2 |
|---|---|---|
| R1 Te (° C.) | 69.5 | 66 |
| R1 Pr (Bar) | 24 | 24 |
| Al/Ti (mol/mol) | 135 | 135 |
| Si/Ti (mol/mol) | 10 | 10 |
| R1 H2/C3 (mol/mol) | 0.065 | 0.05 |
| R1 split (wt %) | 86 | 74 |
| R2 Te (° C.) | 59 | 57 |
| R2 Pr (Bar) | 24 | 24 |
| R2 H2/C3 (mol/mol) | 0.0042 | 0.005 |
| R2 C2/C3 (mol/mol) | 0.31 | 0.33 |
| R2 split (wt %) | 14 | 26 |

In Table 1, R1 refers to the first reactor, R2 refers to the second reactor, Te refers to temperature, Pr refers to pressure, Al/Ti is the molar ratio of the co-catalyst to the procatalyst, Si/Ti is the molar ratio of the external donor to the procatalyst, H2/C3 is the molar ratio of hydrogen to propylene, C2/C3 is the molar ratio of ethylene to propylene, split is the amount of substance produced in R1 or R2 based on the amount of the total Polymer IPC1 and IPC2 respectively.

IPC1 is a heterophasic copolymer having MFI (ISO1133-1:2011, 230° C., 2.16 kg) of 77 dg/min consisting of a matrix of a propylene homopolymer (86 wt %) and a dispersed phase of a propylene-ethylene copolymer (14 wt %). The matrix has MFI (ISO1133-1:2011, 230° C., 2.16 kg) of 230 dg/min.

| | |
|---|---|
| CXS (wt %) | 14 |
| IV_{CXS} (dl/g) | 5.3 |
| IV_{CXI} (dl/g) | 1.3 |
| IV_{CXS}/IV_{CXI} | 4.1 |

Weight percentage of the xylene-soluble part (CXS) of the heterophasic propylene copolymers was determined according to ISO16152:2005. Weight percentage of xylene-insoluble part (CXI) of the heterophasic propylene copolymers was calculated using the following equation:

CXI=100 wt %−CXS

Both xylene-soluble and xylene-insoluble parts (CXS and CXI) obtained in this test were used in the intrinsic viscosity (IV) test.

Intrinsic viscosity (IV) of CXS and CXI was determined according to ISO1628-1:2009 and ISO1628-3:2010 respectively in decalin at 135° C.

IPC2 is a heterophasic copolymer having MFI (ISO1133-1:2011, 230° C., 2.16 kg) of 14 dg/min consisting of a matrix of a propylene homopolymer (74 wt %) and a dispersed phase of a propylene-ethylene copolymer (26 wt %). The matrix has MFI (ISO1133-1:2011, 230° C., 2.16 kg) of 85 dg/min.

| | |
|---|---|
| CXS (wt %) | 21.5 |
| IV_{CXS} (dl/g) | 4 |
| IV_{CXI} (dl/g) | 1.4 |
| IV_{CXS}/IV_{CXI} | 2.9 |

Recycled i-PP1 is B420 commercially available from Morsinkhof.

Recycled i-PP2 is B450 commercially available from Morsinkhof.

Both Recycled i-PP1 and Recycled i-PP2 are produced from post-consumer household packaging waste with properties shown in Table 2.

TABLE 2
Properties of Recycled i-PP1 and Recycled i-PP2.

| | Recycled i-PP1 | Recycled i-PP2 |
|---|---|---|
| Ash content [wt %] ISO 3451 | 1.6 | 1.2 |
| MFI [g/10 min] ISO 1133 | 22 | 16 |
| IZOD notched impact @23° C. | 4.8 | 5.0 |
| [kJ/m²] ISO 180/1A | | |
| Flexural modulus [MPa] ISO 178 | 1371 | 1320 |
| Density [g/cm³] ISO 1183 | 0.92 | 0.905 |

Talc: HAR commercially available from Imerys Talc. The mean particle size of talc (D50) of HAR is 2 microns as measured according to sedimentation analysis, Stokes' law (ISO 13317-3:2001).

POE1 is Tafmer D605 commercially available from Mitsui Chemicals, which is a ethylene-butene copolymer having a density of 0.861 g/cm3 (ASTM D792-13), an MFI of 0.5 g/10 min (ASTM D1238-13, 2.16 kg, 190° C.) and a shore A hardness of 58 (ASTM D2240-15).

POE2 is FORTIFY™ elastomer C5070T commercially available from SABIC, which is an ethylene-1-octene copolymer having an MFI of 5.0 dg/min as measured according to ASTM D1238-13 at 190° C., 2.16 kg and a density of 0.868 g/cm³ as measured according to ASTM D792-13.

Additive package: The additive package comprises 35 wt % stabilizer (standard additives including antioxidants, heat stabilizers, mold release agents, UV stabilizers, process stabilizers) and 65 wt % color masterbatch. The weight percentage is based on the total amount of the additive package.

Components shown in Table 3 were melt-mixed and compositions of CEx 1 and Ex 2-6 were obtained. The properties were measured and shown in Table 3 as well.

TABLE 3

| | | | | | |
|---|---|---|---|---|---|
| CEx 1 | Ex 2 | Ex 3 | Ex 4 | Ex 5 | Ex 6 |

Compositions

| | | | | | | |
|---|---|---|---|---|---|---|
| IPC1 | 60.93 | 51.93 | 35.93 | 35.93 | 24.93 | 9.93 |
| IPC2 | | | | | 30 | 30 |
| recycled i-PP1 | 0 | 10 | 25 | | 10 | 25 |
| recycled i-PP2 | | | | 25 | | |
| POE1 | 15 | 14 | 15 | 15 | 12 | 11 |
| POE2 | 6 | 6 | 6 | 6 | 5 | 6 |
| talc | 15 | 15 | 15 | 15 | 15 | 15 |
| additive package | 3.07 | 3.07 | 3.07 | 3.07 | 3.07 | 3.07 |

Testing results

| | | | | | | |
|---|---|---|---|---|---|---|
| Ash content (%) | 14.3 | 14.9 | 15.0 | 14.8 | 15.1 | 14.7 |
| MFI (g/10 min) | 27.3 | 24.9 | 18.6 | 16.3 | 18.3 | 15.4 |
| Izod notched impact | 35.1 | 40.9 | 44.4 | 46.6 | 49.5 | 46.4 |
| (kJ/m²) | | | | | | |
| Scratch resistance | 6.44 | 5.93 | 3.16 | 4.62 | 3.73 | 1.96 |
| Gloss@20° | 6.8 | 8.1 | 16 | 19 | 8.4 | 18.7 |
| Gloss@60° | 25.9 | 27.6 | 39.5 | 42.1 | 29.3 | 43.3 |
| Gloss@85° | 86.6 | 87.7 | 90.5 | 91.5 | 88.5 | 91.4 |

Ash content was measured according to ISO 3451.

Melt flow index (MFI) was measured according to ISO1133-1:2011 at 230° C. with a 2.16 kg load.

Izod notched impact strength was measured by ISO180/1A (II) at 23° C.

Scratch resistance was measured according to the PV 3952 (2002) scratch method of Volkswagen AG company on an Erichsen scratching device, with a load of 10N. The resulting value dL is a measure for the scratch resistance, a low dL value corresponding to high scratch resistance.

Gloss was measured according to ISO2813 at an angle of 20°, 60° and 85° on injection molded grained specimens.

By comparing comparative example 1 and examples 2-4, it can be seen that the use of recycled i-PP unexpectedly improves the gloss and the scratch resistance of the composition. The improvement of the gloss of the composition is unexpectedly in positive correlation with the amount of the recycled i-PP used. Example 4 demonstrates that a different type of recycled i-PP produces a similar performance of the composition.

A similar improvement in scratch resistance and gloss can also be found in examples 5 and 6, in which a different combination of virgin PP was used.

1. A blended polypropylene composition, comprising
(A) 5 to 50 wt % of a recycled polypropylene composition with a melt flow index of 10 to 50 dg/min as measured according to ISO1133-1:2011 at 230° C. with 2.16 kg load, wherein the recycled polypropylene composition comprises a propylene-based polymer at an amount of at least 90 wt % with respect to the recycled polypropylene composition,
(B) 30 to 70 wt % of at least one heterophasic propylene copolymer with a melt flow index of 10 to 90 dg/min as measured according to ISO1133-1:2011 with 2.16 kg load at 230° C.,
(C) 5 to 30 wt % of an inorganic filler, and
(D) 5 to 30 wt % of at least one polyolefin based elastomer.

2. The blended polypropylene composition according to claim 1,
wherein the Izod notched impact strength of the blended composition is in the range of 37 to 60 kJ/m²; and/or
wherein the gloss of the blended composition is in the range of 7.0 to 30; and/or
wherein the scratch resistance of the blended composition is in the range of 1.0 to 6.2.

3. The blended polypropylene composition according to claim 1, wherein the melt flow index (MFI) of the heterophasic propylene copolymer is in the range from 12 to 80 dg/min, as measured according to ISO1133-1:2011 with a 2.16 kg load at 230° C.

4. The blended polypropylene composition according to claim 1, wherein the heterophasic propylene copolymer consists of
(a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and
(a2) a dispersed ethylene-α-olefin copolymer, wherein the sum of the total amount of propylene-based matrix and total amount of the dispersed ethylene-α-olefin copolymer in the heterophasic propylene copolymer is 100 wt %;
wherein the xylene soluble part of the heterophasic propylene copolymer is in the range from 12.9 to 27.8 wt %, based on the total amount of the heterophasic propylene copolymer as measured according to ISO16152:2005,
wherein the intrinsic viscosity of the xylene soluble part of the heterophasic propylene copolymer is in the range from 3.5 to 6.0 dl/g, as measured according to ISO1628-1:2009 in decalin at 135° C.

5. The blended polypropylene composition according to claim 1, wherein IV_{cxs}/IV_{CXI} is in the range from 2 to 5, in which,
IV_{cxs} is the intrinsic viscosity of the xylene soluble part of the heterophasic propylene copolymer, and IV_{CXI} is the intrinsic viscosity of the xylene insoluble part of the heterophasic propylene copolymer.

6. The blended polypropylene composition according to claim 1,
wherein the propylene-based matrix is present in an amount of 70 to 90 wt %, based on the total heterophasic propylene copolymer and the amount of ethylene monomer units in the ethylene-α-olefin copolymer in the heterophasic propylene copolymer is 34 to 58 wt %.

7. The blended polypropylene composition according to claim 1,
wherein the recycled composition has an ash content as determined by ISO 3451 of less than 10 wt % with respect to the recycled composition,
wherein the recycled composition has a melt flow index as determined by ISO1133-1:2011 at 230° C. with 2.16 kg load of 15 to 30 dg/min,
wherein the recycled composition has an Izod notched impact strength as determined by ISO180/1A at 23° C. of 2.0 to 7.0 kJ/m².

8. The blended polypropylene composition according to claim 1, with respect to the total weight of the blended composition, the amount of the recycled composition is 7 to 35 wt %;
the amount of the at least one heterophasic propylene copolymer is 35 to 65 wt %,
the amount of the inorganic filler with respect to the blended composition is 10 to 25 wt %,
the amount of the at least one polyolefin based elastomer with respect to the blended composition is 10 to 25 wt %.

9. A process for making a blended composition according to claim 1, comprising the steps of:
i) processing a waste plastic material derived from post-consumer and/or post-industrial waste to obtain (A) a recycled polypropylene composition,
ii) melt-mixing the recycled polypropylene composition with (B) at least one heterophasic propylene copolymer, (C) an inorganic filler and (D) at least one polyolefin based elastomer.

10. A blended composition prepared by the process of claim 9.

11. A process for preparing an article comprising the process of claim 9 and the step of injection molding the blended composition to obtain the article.

12. An article comprising the blended composition according to claim 1.

13. The article according to claim 12, wherein the article is an automotive part selected from the group consisting of exterior and interior, visible and partly visible applications, like bumper fascias, rocker panels, trims, cowl tops, cowl vent grill, windshield plenum, door panel, IP trim parts, seat claddings, center console, cup holders and arm, glove compartment and under-the-hood applications, like head-lamp housings.

14. A method for improving impact strength and gloss of a composition, the method comprising blending (A) a recycled composition obtained by processing a waste plastic material derived from post-consumer and/or post-industrial waste (B) at least one heterophasic propylene copolymer, (C) an inorganic filler and (D) at least one polyolefin based elastomer.
